(19) United States
(12) Patent Application Publication
(10) Pub. No.: US 2016/0173701 A1
(43) Pub. Date: Jun. 16, 2016

(54) TECHNIQUES FOR MESSAGE AGGREGATOR TESTING AND SELECTION

(71) Applicant: Facebook, Inc., Menlo Park, CA (US)

(72) Inventors: Sumit Rasiwasia, Hyderabad (IN); Surendra Gadodia, Fremont, CA (US); Xiao Liang, Mountain View, CA (US); Antony T. Fu, Cupertino, CA (US)

(73) Assignee: FACEBOOK, INC., Menlo Park, CA (US)

(21) Appl. No.: 14/570,783

(22) Filed: Dec. 15, 2014

(51) Int. Cl. H04M 15/00; H04W 4/14; G06Q 30/08; H04W 4/26

(52) U.S. Cl. CPC H04M 15/60; H04W 4/26; H04W 4/14; G06Q 30/08

(57) ABSTRACT

Techniques for message aggregator testing and selection are described. In one embodiment, an apparatus may comprise an aggregator contact component, an aggregator selection component, and a messaging component. The aggregator contact component may receive a plurality of bids from a plurality of message aggregators. The aggregator selection component may select two or more candidate aggregators of the plurality of message aggregators, estimate a price-per-delivery rate for each of the two or more candidate aggregators, and select a contracting aggregator based on the price-per-delivery rate for each of the two or more candidate aggregators. The messaging component may submit a plurality of messages to each of the two or more candidate aggregators, receive a plurality of message confirmations in response to the plurality of messages, and determine the delivery rate for each of the two or more candidate aggregators. Other embodiments are described and claimed.

### BACKGROUND

A message aggregator may receive messages, such as Short Message Service (SMS) messages, and retransmit them to forward the process of those messages reaching users. The message aggregator may receive messages over a variety of network interfaces, including an Internet-based network interface. The message aggregator may transmit the messages to messaging endpoints (e.g., cellular telephones) either directly or through an another intermediary, such as the Short Message Service Center (SMSC) for a cellular operator. A number of different message aggregators may be available for performing the service of forwarding messages to message recipients. The message aggregators may charge a per-message fee for each message received. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for message aggregator testing and selection. Some embodiments are particularly directed to techniques for message aggregator testing and selection that leverages messages with a high user response rate to perform accurate testing of aggregator delivery quality. In one embodiment, for example, an apparatus may comprise an aggregator contact component, an aggregator selection component, and a messaging component. The aggregator contact component may be operative to receive a plurality of bids from a plurality of message aggregators, each of the plurality of bids comprising a price-per-message rate. The aggregator selection component may be operative to select two or more candidate aggregators of the plurality of message aggregators, wherein at least one candidate aggregator is selected according to the price-per-message rate, estimate a price-per-delivery rate for each of the two or more candidate aggregators based on a delivery rate and bid for each of the two or more candidate aggregators, and select a contracting aggregator based on the price-per-delivery rate for each of the two or more candidate aggregators. The messaging component may be operative to submit a plurality of messages to each of the two or more candidate aggregators, receive a plurality of message confirmations in response to the plurality of messages, and determine the delivery rate for each of the two or more candidate aggregators based on a confirmation count of the received plurality of message confirmations as compared to a submission count of the submitted plurality of messages. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a message aggregator auction system.

FIG. 2 illustrates an embodiment message aggregator auction server for a message aggregator auction system.

FIG. 3 illustrates an embodiment of the message aggregator auction system in which message confirmations are received via a social networking server.

FIG. 4 illustrates an embodiment of the message aggregator auction system in which a personal computer device is used to register a mobile device with a social networking server.

FIG. 5 illustrates an embodiment of the message aggregator auction system in which the message aggregators are evaluated in a pre-auction testing phase.

FIG. 6 illustrates an embodiment of the message aggregator auction system in which the deadline for bids is extended in response to a received additional bid.

FIG. 7 illustrates an embodiment of a logic flow for the system of FIG. 1.

FIG. 8 illustrates an embodiment of a centralized system for the system of FIG. 1.

FIG. 9 illustrates an embodiment of a distributed system for the system of FIG. 1.

FIG. 10 illustrates an embodiment of a computing architecture.

FIG. 11 illustrates an embodiment of a communications architecture.

FIG. 12 illustrates an embodiment of a radio device architecture.

### DETAILED DESCRIPTION

Various embodiments are directed to techniques for the testing of message aggregators and the selection of message aggregators based on performance-based criteria. A message aggregator may receive messages addressed to a destination device and forward the messages to the destination device, in some cases through another intermediary device or service. A Short Message Service (SMS) aggregator may serve as an intermediary between a producer of SMS messages, such as a network-based service that produces messages for users of the service, and the Short Message Service Centers (SMSCs) of the cellular operators providing cellular service to the mobile devices of the users. The aggregators may receive the SMS messages and forward them to the SMSCs for the cellular operators.

Different aggregators may provide this service to differing degrees of quality. The quality of an aggregator may refer to the success of the aggregator in delivering messages submitted to it to their final destination. Multiple different issues may arise in the delivery of a message. An aggregator may fail internally, such as its own queue being full, downtime, data loss, or other failures. An aggregator submitting a message to a service providing the next stage of delivery such as an SMSC may experience an ability to connect to the SMSC due to downtime, an SMSC queue being full, or other complications with an SMSC. In some cases, an aggregator may be able, if properly designed, equipped, and operated, to accommodate these complications. In general, therefore, while some failures of message delivery may be outside the control of a message aggregator, many failures may be avoided by an aggregator. As such, aggregators may be evaluable according to the portion (e.g., percentage or fraction) of messages submitted to the aggregator that are successfully received by the destination device.

Unfortunately, for some types of messages the destination devices or delivery services may not be equipped or configured to report that a message was delivered. The protocol used for encoding and delivery of a message may not support, implement, or enforce message receipts. For instance, the SMS protocol used for delivering SMS messages does not report delivery back to the sender of an SMS message. As such, it is advantageous to have a proxy measure for message delivery rate.

Some messages may prompt user action on a channel perceptible to the sender of a message. A user may be in contact with a network-based service using two or more channels in parallel, sequence, or alternation, such as an SMS channel and a web channel. For example, a user may register a mobile device, identified by a telephone number, with a network-based service via a web frontend so as to receive alerts or other information from the service via SMS message on the mobile device. The service may send an SMS message to the mobile device, the SMS message comprising an alphanumeric code. The user may be required to enter the alphanumeric code received via SMS at the web frontend to verify that the user is in possession of the mobile device. Because the message is sent in response to a user registration request the user may be assumed to have a significant interest in responding to the message via registration. Because the message is sent promptly after a registration request the message may be likely to be received at a time when the user has the opportunity to respond to the message via the web frontend. As such, due to user motivation and opportunity, a very high percentage of SMS messages comprising a confirmation code may result in a user entering the code in the web frontend once received. Further, user response rate to the confirmation message may be independent of the aggregator used, such that the small percentage of users not responding to a confirmation message may equally count against every aggregator being considered and therefore not prejudice a decision between aggregators. Therefore, the response rate to confirmation requests may serve as a useful proxy measure for the delivery rate for messages. A network-based service producing a sufficient volume of confirmation messages may therefore exclusively use confirmation messages to determine the quality of an aggregator due to their high response rate and independence from aggregator selection.

Message aggregators may charge for user of their message forwarding service. Message aggregators may use a price-per-message fee with this fee charged for every message submitted, independent of whether the message is delivered. A message aggregator may be disinclined to charge a price-per-delivery fee due to both the difficulty or impossibility of determining whether a message is delivered and an unwillingness to accept the responsibility of failed message delivery to, for example, devices that are use in areas with poor connectivity, devices that are frequently unavailable, and devices that are associated with an unreliable service provider. However, a network-based service evaluating between message aggregators may be benefited by comparing aggregators according to an approximated price-per-delivery in order to determine how much they will pay for each message which actually serves their business purpose (i.e., the communication of information to a user). It will be appreciated that additional fees may be associated with contracting with a message aggregator, such as a flat fee for a particular time period, a minimum fee over a particular time period, or other fee not represented by a price-per-message fee or an approximated price-per-delivery fee. It will be appreciated, however, that an approximated price-per-delivery fee may still be useful in selecting a message aggregator. As a result, the embodiments can improve the affordability and reliability of a network-based service.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

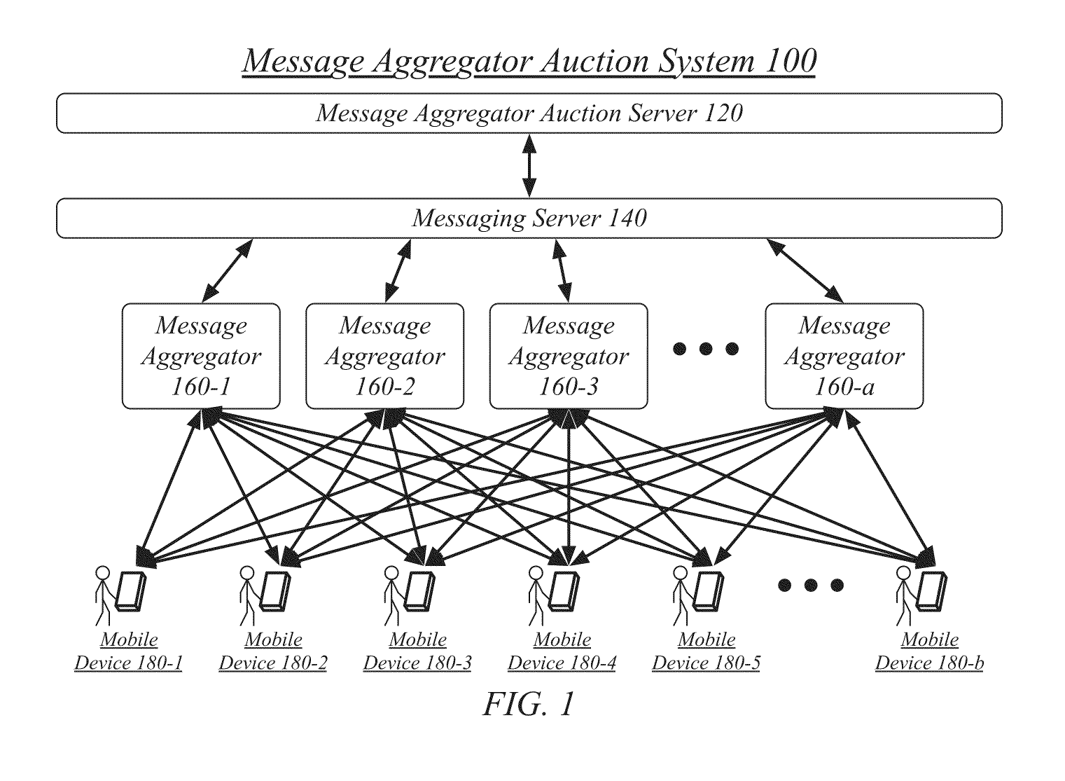

FIG. 1 illustrates a block diagram for a message aggregator auction system 100. It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

A network-based service may maintain at least a message aggregator auction server 120 and a messaging server 140 in the performance of their network operations. The message aggregator auction server 120 and the messaging server 140 may be implemented by a same computing device, such as a centralized server device, or by distinct computing devices, such as in a multi-server environment, distributed computing environment, or distributed hosting environment.

The message aggregators 160 may comprise a plurality of aggregators contracting with, in consideration by, or otherwise available to the messaging server 140 for the delivery of messages. Message aggregators 160 may comprise a group of aggregators providing service to a particular segment of users. For instance, message aggregators 160 may comprise messages aggregators 160 for a particular geographic area such as a country. Message aggregators 160 may comprise SMS aggregators. Message aggregators 160 may be generally arranged to receive messages and arrange for the delivery of those messages to their destination devices. The delivery of those messages may be unreliable, that unreliability may vary according to the message aggregator, and the message aggregators 160 may refrain from reporting the delivery or failure of delivery of messages to a transmitting messaging server 140.

Mobile devices 180 may comprise a plurality of devices available for messaging communication by the messaging server 140 via the message aggregators 160. Mobile devices 180 may correspond to a pool of devices being registered with a network-based service for the receipts of messages from the network-based service. Mobile devices 180 may comprise cellular devices such as cellular telephones, smartphones, etc.

A message aggregator auction server 120 may manage the testing of message aggregators 160. The message aggregator auction server 120 may receive a list of message aggregators 160 interested or available in providing messaging aggregation for the network service. The message aggregator auction server 120 may receive bids from some or all of the message aggregators 160. The message aggregator auction server 120 may manage the testing of one or more of the message aggregators 160. The message aggregator auction server 120 may evaluate the testing of the one or more of the message aggregators 160 and determine and select a preferred message aggregator based on the testing.

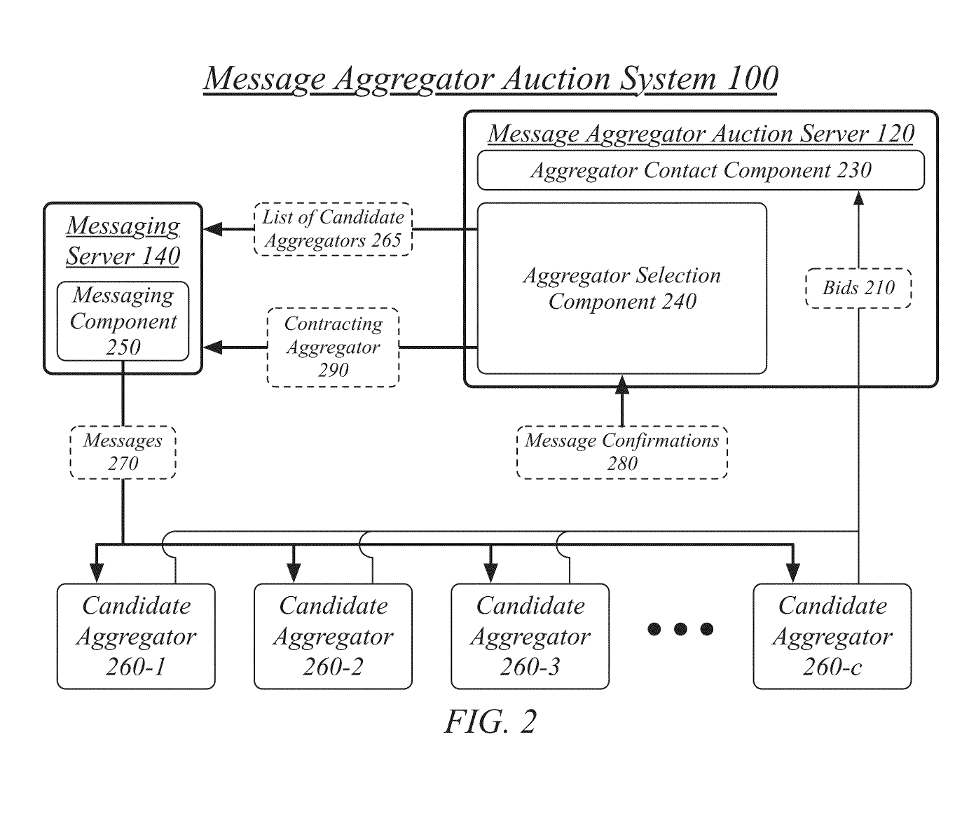

FIG. 2 illustrates a block diagram for a message aggregator auction server 120 for a message aggregator auction system 100. In one embodiment, the message aggregator auction system 100 may comprise a computer-implemented system. Although the message aggregator auction system 100 shown in FIG. 2 has a limited number of elements in a certain topology, it may be appreciated that the message aggregator auction system 100 may include more or less elements in alternate topologies as desired for a given implementation.

The message aggregator auction server 120 may be generally arranged to perform the selection of a message aggregator. The message aggregator auction server 120 may be generally arranged to manage a messaging server 140 for the performance of message aggregator testing. The message aggregator auction server 120 may comprise an aggregator contact component 230 and an aggregator selection component 240.

The aggregator contact component 230 may be operative to receive a plurality of bids 210 from a plurality of message aggregators 160, each of the plurality of bids comprising a price-per-message rate. The bids 210 may be received electronically from the message aggregators 160, such as from a server device for each of the message aggregators 160. The bids 210 may be received using an application programming interface (API) for the submission of business information including bids 210. The bids may be received in response to a request from the message aggregator auction server 120.

The bids may be received in response to a request for proposal (RFP) produced by a network-based service. The plurality of bids 210 may be received as bids for message aggregation for a business entity providing the network-based service. The plurality of bids may be received as bids for message aggregation for the network-based service. The RFP may specify a deadline for the receipt of bids. The RFP may specify a schedule of deadlines for the periodic receipt of bids, such as only a quarterly, bi-annual, annual, or other basis. Bids 210 may be received according to the deadline specified by an RFP. Deadline may be provisional in that they may be extended, such as in response to additional bids received close to the provisional deadline. The RFP may specify a plurality of rules for the bid process, including deadlines, rules for the extension of deadlines, specifications for the submission of bids, rules for the evaluation process, and any other rules related to the process of receiving bids and the selection of a message aggregator.

The aggregator selection component 240 may be operative to select two or more candidate aggregators 260 of the plurality of message aggregators 160. Various criteria may be used for the selection of the candidate aggregators 260. Various criteria may be used in combination, such that each criteria selects one or more message aggregator for inclusion in the candidates. At least one candidate aggregator may be selected according to the price-per-message rate. The message aggregator with the lowest price-per-message rate may be selected as a candidate aggregator. In some embodiments, a predefined number of the plurality of message aggregators 160 with the lowest price-per-message rates may be selected as candidate aggregators. For instance, where the predefined number is two, the two message aggregators of the plurality of message aggregators 160 with the two lowest price-per-message rate bids may be selected as candidate aggregators of the plurality of candidate aggregators 260.

In some cases, a current message aggregator may be in use by the network-based service. The current message aggregator may provide message aggregation to the network-based service. The current message aggregator may be selected as at least one of the candidate aggregators 260. During the evaluation of the candidate aggregators 260, a portion of the messages produced by the network-based service may be redirected for use in the evaluation. The remaining portion may still be directed through the current message aggregator as part of the existing business relationship between the network-based service and the current message aggregator. Where only a particular category of messages are used for the evaluation of aggregators, any messages that are not part of that particular category and any messages that are part of that particular category but that aren't used for evaluation may be transmitted via the current message aggregator. In general, the current message aggregator may be used for any messages that aren't used for the evaluation of the candidate aggregators 260. In addition, where the current message aggregator is included in the candidate aggregators 260 a portion of the messages 270 used for the evaluation of candidate aggregators 260 may be sent through current message aggregator to evaluate the current message aggregator.

In some cases, pre-auction evaluation of the plurality of message aggregators 160 may be performed to determine a pre-auction, provisional delivery rate (quality measure) for each of the plurality of message aggregators 160. The pre-auction delivery rate for each of the plurality of message aggregators 160 may be compared to a minimum threshold acceptable delivery rate. At least one candidate aggregator may be selected according to the price-per-message rate from among those message aggregators 160 that meet the minimum threshold acceptable delivery rate. The message aggregator with the lowest price-per-message rate that also meets the minimum threshold acceptable delivery rate may be selected as one of the candidate aggregators 260. In some embodiments, one or more candidate aggregators may be selected according to having the lowest price-per-message rate without restriction by a minimum threshold acceptable delivery rate and one or more candidate aggregators may be selected according to have the lowest price-per-message rate of those message aggregators that satisfy a minimum threshold acceptable delivery rate.

The messaging server 140 may be generally arranged to perform messaging on behalf of a network-based service. The messaging server 140 may be operative to receive messages originated within the service and to transmit them outside the service, such as via message aggregators 160. The messaging server 140 may comprise a messaging component 250. A plurality of messages 270 may be transmitted from a network-based service to users of the network-based service by the messaging component 250 of the messaging server 140. The messaging server 140 may comprise one of a plurality of messaging servers used by the network-based service.

The messaging server 140 may receive a list of candidate aggregators 265 from the message aggregator auction server 120. The list of candidate aggregators 265 may identify the candidate aggregators 260 that are to be evaluated using messages 270 transmitted by the message server 140. The list of candidate aggregators 265 may include identifiers for the candidate aggregators 260, network addresses for the candidate aggregators 260, and/or any other configuration information for configuring the messaging component 250 to submit messages to the candidate aggregators 260 for evaluation of the candidate aggregators 260.

The messaging component may be operative to submit a plurality of messages 270 to each of the two or more candidate aggregators 260. The messages 270 may comprise SMS messages. The messages 270 may comprise messages that are produced as part of the general operation of a network-based service rather than being messages produced specifically as test messages for the purpose of testing. The use of messages 270 for the evaluation of candidate aggregators 260 may comprise a redirection of existing messages from using an existing contracted message aggregator to using the candidate aggregators 260 for the purpose of evaluating the candidate aggregators 260. The plurality of messages 270 may comprise mobile phone registration confirmation request messages, the mobile phone registration confirmation request messages produced in response to registration of mobile phones with the network-based service. Users may attempt to register their mobile phones with the network-based service and receive a mobile phone registration confirmation message to confirm that they are the operator of the mobile phone being registered.

The aggregator selection component 240 may be operative to receive a plurality of message confirmations 280 in response to the plurality of messages 270 submitted to each of the two or more candidate aggregators 260. The message confirmations 280 may correspond to any confirmation that a destination device has received a particular message. The message confirmations 280 may be received from a variety of sources. The message confirmations 280 may be received from the message server 140. The message confirmations 280 may be received directly from the candidate aggregators 260. The message confirmations 280 may be received from the destination devices via a channel distinct from that used for the transmission of the messages 270, such as where the messages 270 are SMS messages and the message confirmations 280 are received via a Web frontend.

The aggregator selection component 240 may be operative to determine a delivery rate for each of the two or more candidate aggregators 260 based on a confirmation count of the received plurality of message confirmations 280 as compared to a submission count of the submitted plurality of messages 270. The submission count for each of the candidate aggregators 260 may comprise a number of messages sent through each candidate aggregator. The confirmation count for each of the candidate aggregators 260 may comprise a number of messages confirmations received for messages sent through each candidate aggregator. The confirmation count for each of the candidate aggregators 260 may be incremented at most once for the confirmation of any one message sent through a candidate aggregator, such that each message may only be counted as confirmed once for the purposes of evaluating the candidate aggregators. The delivery rate for a candidate aggregator may be equal to the confirmation count for that candidate aggregator divided by the submission count for that aggregator. In various embodiments, and without limitation, the delivery rates for the candidate aggregators 260 may be expressed as a percentage, fraction, proportion, ratio, or any other technique for the expression and storage of a rate or measure.

The aggregator selection component 240 may be operative to estimate a price-per-delivery rate for each of the two or more candidate aggregators 260 based on a delivery rate and bid for each of the two or more candidate aggregators 260. The price-per-delivery rate may be estimated for a candidate aggregator as the delivery rate estimated for the candidate aggregator multiplied by the price-per-message from the bid by the candidate aggregator. For example, where the delivery rate is estimated as 90% and the price-per-message was bid at 10¢ per message, the price-per-delivery may be estimated at 9¢ per message. It will be appreciated that as the delivery rate is an estimate that may include a lack of confirmation that did not result from a failure to deliver, that the determined delivery rate may under-report the actual rate of message delivery. However, with a sufficiently large sample size, this under-estimation of the actual rate of message delivery may be sufficiently equal between candidate aggregators that the estimated price-per-delivery rate is still a fair measure of the candidate aggregators 260.

The aggregator selection component 240 may be operative to select a contracting aggregator 290 based on the price-per-delivery rate for each of the two or more candidate aggregators 260. The contracting aggregator 290 may be selected as the candidate aggregator with the lowest price-per-delivery rate of the plurality of candidate aggregators 260. In some cases, a minimum threshold acceptable delivery rate may be specified for message aggregation. In these cases, only those candidate aggregators that meet (i.e., equal or exceed) the minimum threshold acceptable delivery rate may be selected from among in selecting the contracting aggregator 290. As such, the aggregator selection component 240 may be operative to select a contracting aggregator 290 as the candidate aggregator with the lowest price-per-delivery rate of those candidate aggregators with a determined delivery rate at least equal to a minimum threshold acceptable delivery rate.

The aggregator contact component 230 may transmit the contracting aggregator 290 an acceptance of the bid for the contracting aggregator 290. The aggregator selection component 240 may transmit a notification of the contracting aggregator 290 being selected to the aggregator contact component 230. The aggregator contact component 230 may automatically transmit acceptance of the bid to the contracting aggregator 290 in response to the selecting of the contracting aggregator 290 by the aggregator selection component 240. The aggregator selection component 240 may also notify the messaging server 140 of the contracting aggregator 290 being selected to configure the messaging server 140 to use the contracting aggregator 290. The configuring of the messaging server 140 to use the contracting aggregator 290 may be automatically performed in response to the selecting of the contracting aggregator 290.

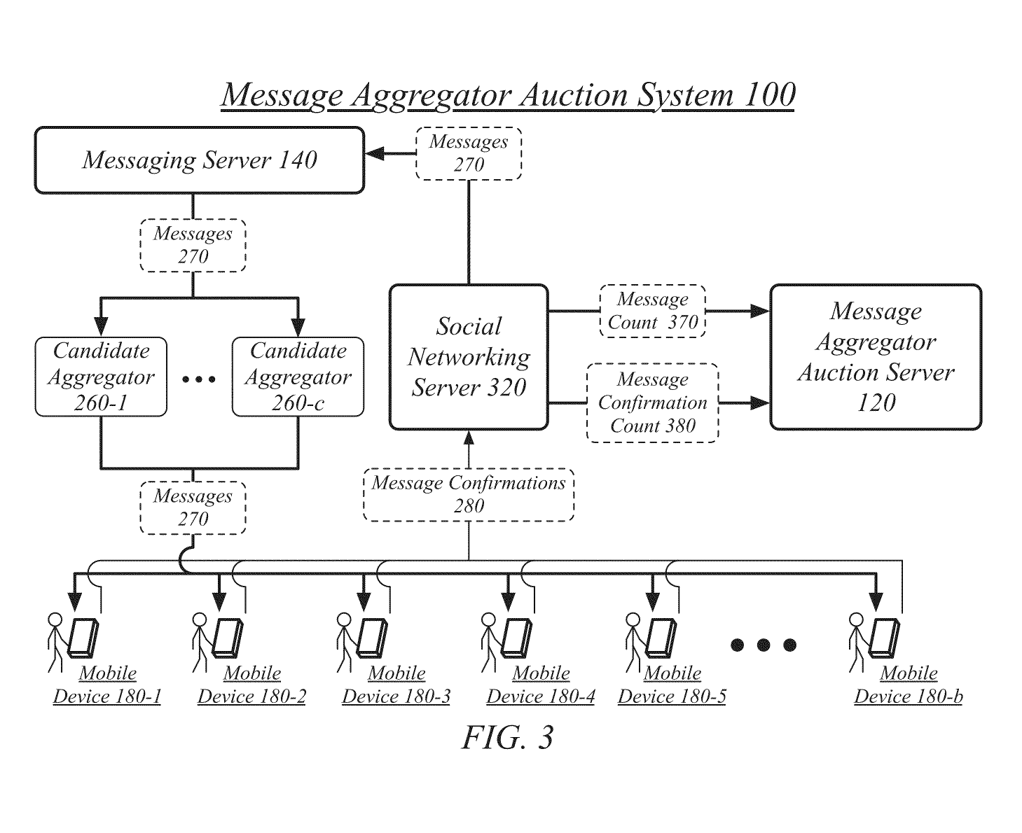

FIG. 3 illustrates a block diagram of the message aggregator auction system 100 in which message confirmations 280 are received via a social networking server 320.

A social networking server 320 may comprise one server of one or more servers implementing a social networking system such as may comprise a network-based service. The social networking server 320 may comprise a distributed server executed on a plurality of server devices such as in a grid computing or distributed computing environment. The social networking server 320 may be operative to receive, send, exchange, generate, and otherwise handle messages in performance of a social networking system.

The social networking server 320 may generate or forward messages 270 to a messaging server 140. It will be appreciated that the messaging server 140 may be executed by a same computing device as the social networking server 320 or a distinct computing device from the social networking server 320. The messaging server 140 may distribute the messages 270 among the candidate aggregators 260 for delivery to the mobile devices 180. The candidate aggregators 260 may thereafter act to deliver the messages 270 to the mobile devices 180, with each of the candidate aggregators 260 acting to deliver a portion of the messages 270 respectively assigned to them.

It will be appreciated that the messages 270 may comprise only a portion of the messages handled by the social networking server 320 and messaging server 140. The messages 270 may be selected as corresponding to one or more categories selected for the testing of the candidate aggregators 260. A first category may comprise a type of message, such as messages requesting the confirmation of a mobile device. A second category may comprise a geographical area, such as messages directed to devices in a particular geographic region (e.g., country) for which a message aggregator is being selected. The messages 270 may be selected as a subset of a plurality of messages handled by the social networking server 320 and/or messaging server 140, the subset determined as being at least a portion of those messages matching all of the categories being used for testing. In a first instance, all of the mobile-device confirmation requests for a particular geographic area may be used for evaluating the candidate aggregators 260. In a second instance, only a portion of the mobile-device confirmation requests for a particular geographic area may be used for evaluating the candidate aggregators 260. The messages 270 used for testing may be distributed among the candidate aggregators 260 equally.

Some or all of the mobile devices 180 may generate message confirmations 280, the message confirmations 280 indicating at least the reception of the messages 270 by the mobile devices 180. The message confirmations 280 may also indicate or contain additional information being communicated from the mobile devices 180 to the social networking server 320. The message confirmations 280 may be generated automatically by the mobile devices 180 in response to the reception of the messages 270. The message confirmations 280 may be generated by the users of the mobile devices 180 in response to the messages 270 and transmitted based on the input of the users.

The message confirmations 280 may be transmitted to the social networking server 320 using a different communication channel than used for the delivery of the messages 270 to the mobile devices 180. An SMS protocol may be used to transmit the messages 270 while the hypertext transport protocol (HTTP), hypertext transport protocol secure (HTTPS), or other web protocol may be used to transmit the message confirmations 280.

The social networking server 320 may track a message count 370 counting the number of messages 270 given to and used by the messaging server 140 for testing the candidate aggregators 260. The social networking server 320 may track a message confirmation count 380 counting the number of message confirmations 280 received by the social networking server 320. The message count 370 and message confirmation count 380 may be used to estimate the delivery rate for each of the candidate aggregators 260 based on the message count 370 and the message confirmation count 380. The message count 370 may indicate the number of messages used for testing each of the candidate aggregators 260. The message confirmation count 380 may indicate the number of message confirmation received in response to messages used for testing each of the candidate aggregators 260. The estimated delivery rate for each of the candidate aggregators may be calculated as the message confirmation count 380 for each candidate aggregator divided by the message count 270 for that candidate aggregator. In some embodiments, the message count 370 and message confirmation count 380 may be transmitted to the message aggregator auction server 120. In some embodiments, the estimated delivery rates for the candidate aggregators 260 may be transmitted to the message aggregator auction server 120.

Message aggregator auction system 100 may include an authorization server (or other suitable component(s)) that allows users to opt in to or opt out of having their messages used by message aggregator auction system 100 or shared with other systems (e.g., third-party systems), for example, by setting appropriate privacy settings. Users may be empowered to opt in to or opt out of having their messages used for testing. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. For example, privacy settings of a user may specify whether their private data, including messages, may be used for testing. Authorization servers or other authorization components may be used to enforce one or more privacy settings of the users of the message aggregator auction system 100 through blocking, data hashing, anonymization, or other suitable techniques as appropriate.

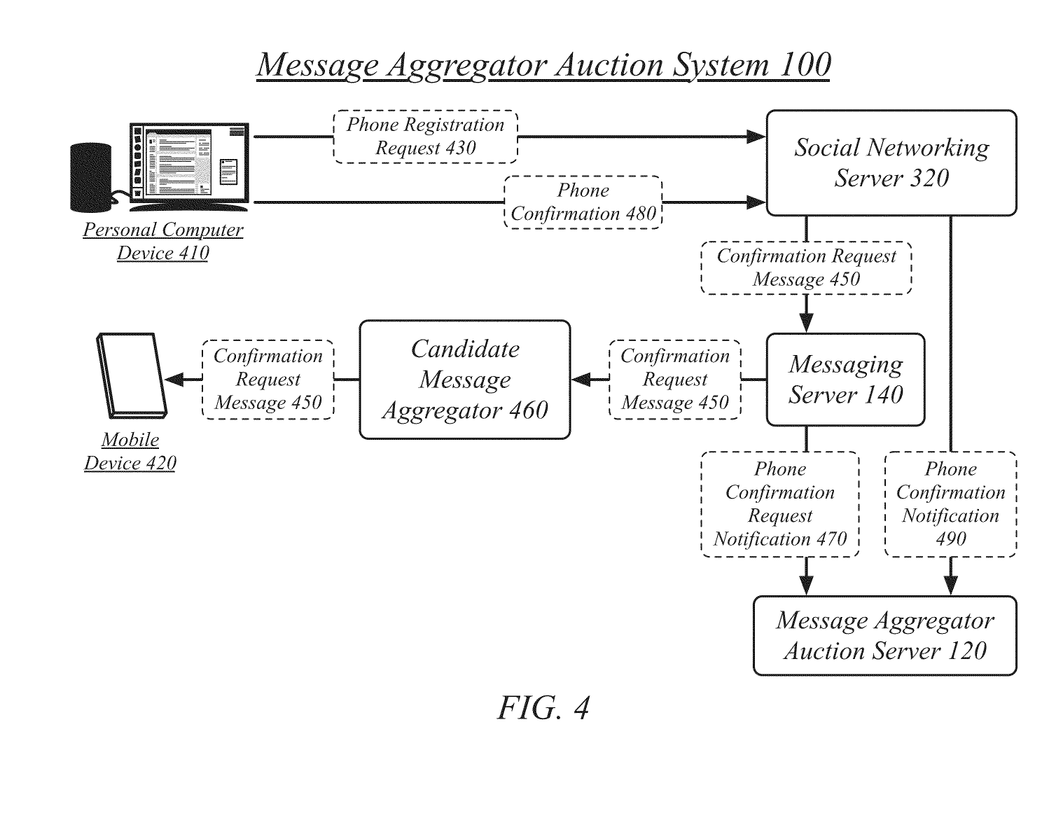

FIG. 4 illustrates a block diagram of the message aggregator auction system 100 in which a personal computer device 510 is used to register a mobile device 520 with a social networking server 320.

A user may use both a personal computer device 410 and a mobile device 420. The personal computer device 410 may comprise a distinct device from the mobile device 420 for a user. The personal computer device 410 may execute a web browser, the web browser used to communicate with the social networking server 320 for a social networking service.

The personal computer device 410 may be used by a user, such as via a web browser, to register, update, or modify an account with a social-networking service. Registering, updating, or modifying an account with a social-networking service may include the specification of a phone number for a mobile device 420, the specification of the phone number communicated in a phone registration request 430. It will be appreciated that the phone registration request 430 may be only one component of a plurality of requests made as part of registering, updating, or modifying an account. The phone registration request 430 may be received by the social networking server 320 from the personal computer device 410.

The social networking server 320 may generate a confirmation request message 450 in response to the received phone registration request 430. The confirmation request message 450 may include a confirmation code generated by the social networking server 320 for use by the user in verifying their receipt of the confirmation request message 450. The messaging server 140 may transmit the confirmation request message 450 to a candidate message aggregator 460 for delivery to the mobile device 420. The candidate message aggregator 460 may be tasked with delivery of the confirmation request message 450 both to advance the registration of the mobile device 420 with the social-networking service and to test the candidate message aggregator 460. The candidate message aggregator 460 may deliver the confirmation request message 450 to the mobile device 420, or may fail to do so and thereby lower its actual deliver rate. The candidate message aggregator 460 may comprise one of the candidate aggregators 260 and the confirmation request message 450 may comprise one of the message 270 used for testing the candidate aggregators 260 as described with reference to FIG. 2. As such, the plurality of messages 270 may comprise mobile phone registration confirmation messages, the mobile phone registration confirmation messages produced in response to registration of mobile phones with the network-based service.

The user may use the personal computer device 410 to transmit a phone confirmation 480 to the social networking server 320. The phone confirmation 480 may comprise the confirmation code included in the confirmation request message 450, the confirmation code used by the social networking server 320 to verify that the user had access to the mobile device 420 in order to receive and view the confirmation code. The phone confirmation 480 may be received by the social networking server 320, used to verify the possession of the mobile device 420 by the user, and thereby used to complete the registration of the mobile device 420 with the account of the user for the social-networking service.

The message aggregator auction server 120 may receive a phone confirmation request notification 470 indicating to the message aggregator auction server 120 that a confirmation request message 450 is being used for testing a mobile device 420. The confirmation request notification 470 may indicate the specific candidate message aggregator 460 being tested with that particular confirmation request message 450. Where a phone confirmation 480 of the confirmation request message 450 is received by the social networking server 320 a phone confirmation notification 490 may be transmitted to the message aggregator auction server 120. The phone confirmation notification 490 may indicate the specific candidate message aggregator 460 that was being tested with confirmation request message 450 generating the phone confirmation 480. In other embodiments, the message aggregator auction server 120 may receive a unified report for each confirmation request indicating whether each confirmation request was successfully verified, with the delivery rate calculated therefrom.

It will be appreciated that in some cases the phone registration request 430 may be generated by the mobile device 420 rather than a separate personal computer device 410. A web browser on the mobile device 420 may be used to produce the phone registration request 430. A mobile app may be used to produce the phone registration request 430. The mobile app may be an application specifically associated with a network-based service, such as an application produced by a social-networking service for use with the social-networking service. A social-networking app may empower a user to register an account with the social-networking service. As part of the registration of the account, or as part of providing additional information for the account, a phone number for the mobile device 420 may be specified, prompting the sending of the confirmation request message 450.

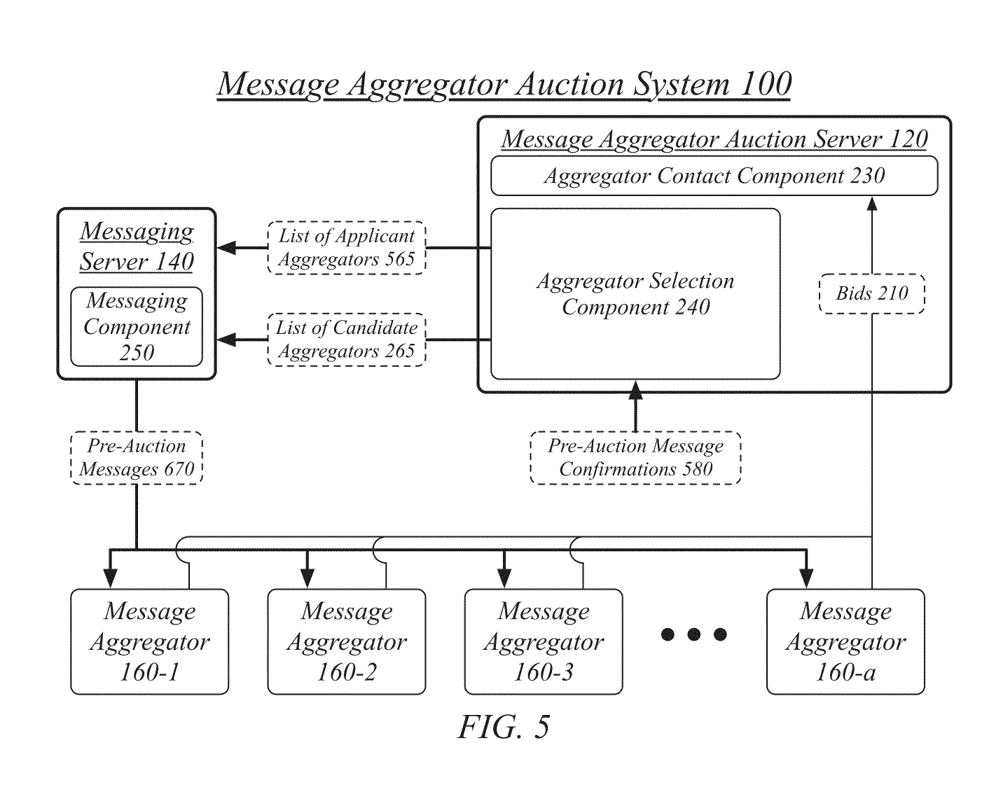

FIG. 5 illustrates a block diagram of the message aggregator auction system 100 in which the message aggregators 160 are evaluated in a pre-auction testing phase. In some cases a pre-auction testing phase may be performed in order to evaluate the message aggregators 160 prior to the receipt of their bids 270 and the selection of candidate aggregators 260.

The aggregator selection component 240 may transmit a list of application aggregators 565 to the message server 140. The message server 140 may thereafter submit a plurality of pre-auction messages 670 to the plurality of message aggregators 160. The pre-auction messages 670 may be selected according to criteria similar or identical to the criteria for the selection of the messages 270.

The aggregator selection component 240 may receive a plurality of pre-auction message confirmations 580 in response to the plurality of pre-auction messages 670. As with the post-auction testing, the pre-auction message confirmations 580 may comprise a count of the confirmations received from a social networking server 320. The pre-auction message confirmations 580 may be received by the social networking server 320 via a web or app interface with a social-networking service while the pre-auction message 670 were transmitted as SMS messages. The aggregator selection component 240 may determine a pre-auction delivery rate for each of the plurality of message aggregators 160 based on a pre-auction confirmation count of the received plurality of pre-auction message confirmations 580 as compared to a pre-auction submission count of the submitted plurality of pre-auction messages 670.

In some embodiments, the two or more candidate aggregators may be selected based on a minimum threshold pre-auction delivery rate. For instance, a minimum acceptable threshold pre-auction delivery rate may be compared to the estimated delivery rate for each of the message aggregators 160 with only those message aggregators meeting the minimum acceptable threshold being allowed to submit bids 210 or being eligible to advance as candidate aggregators 260. In some embodiments, at least one candidate aggregator of the two or more candidate aggregators 260 may be selected according to a pre-auction price-per-delivery rate. The pre-auction price-per-delivery rate for each of the plurality of message aggregators 160 may be estimated based on the determined pre-auction delivery rate and bid for each of the plurality of message aggregators 160. The at least one candidate aggregator may be selected as the candidate aggregator with the lowest estimated pre-auction price-per-delivery rate.

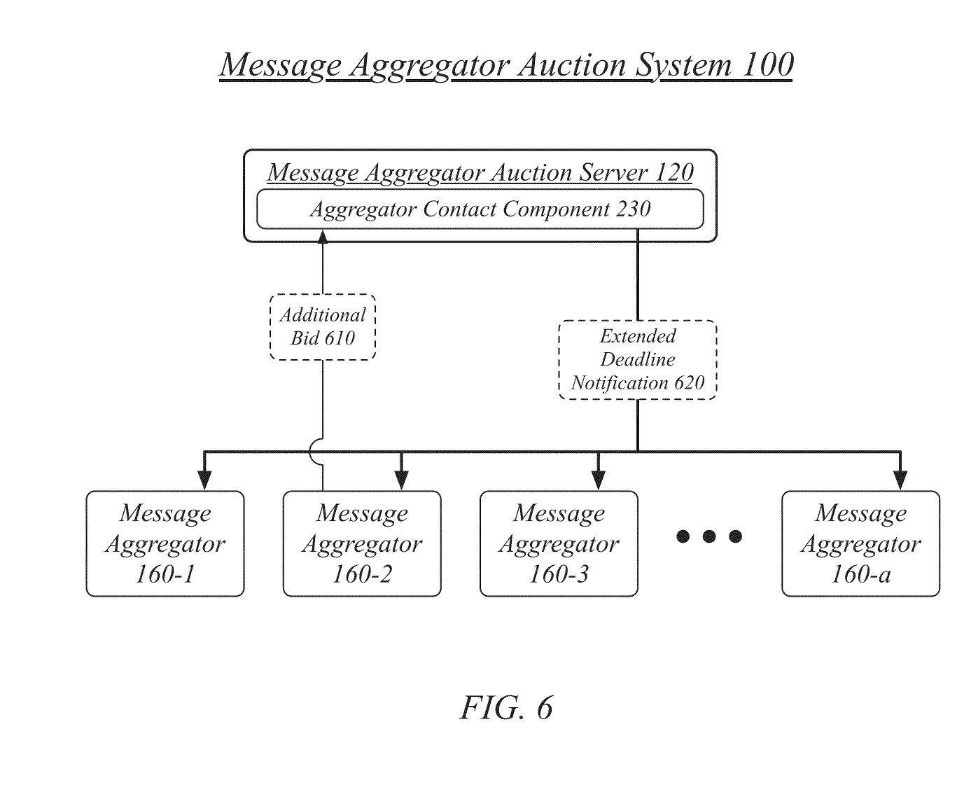

FIG. 6 illustrates a block diagram of the message aggregator auction system 100 in which the deadline for bids is extended in response to a received additional bid 610.

In some cases, the deadline for the submission of bids may be a provisional deadline subject to extension when an additional bid 610 is received. The bids 210 submitted to the aggregator contact component 230 may be public or shared among the message aggregators 160 to allow the message aggregators 160 to respond to the bids of their competitors. This may serve to generally lower the final bid prices as message aggregators 160 compete with each other to produce the lowest bid or the lowest effective price-per-delivery once estimated delivery rate is calculated. As such, where an additional bid 610 is received near the end of the bidding period additional time may be added to the bidding period to allow the message aggregators 160 time to respond to the additional bid 610.

The plurality of message aggregators 160 may be transmitted an extended deadline notification 620 in response to the extension of the provisional deadline. The extended deadline notification 620 may indicate a length of time that the provisional deadline has been extended and a new time for the extinction of the new provisional deadline. The extended deadline notification 620 may also include the value of the additional bid 610 so as to notify the message aggregators 160 of the new lowered bid of one of their competing message aggregators.

In some embodiments, a hard deadline may be used after which the provisional deadline will not be extended. In some embodiments, a limited number of bid extensions may be allowed. In some embodiments, the length of bid extensions may be reduced with each extension. In general, one or more techniques may be used to ensure that the bid process is eventually concluded. However, in some embodiments the bid process may be open to indefinite extension so long as one or more of the message aggregators 160 continue to submit lowered bids before the extinction of a provisional deadline.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

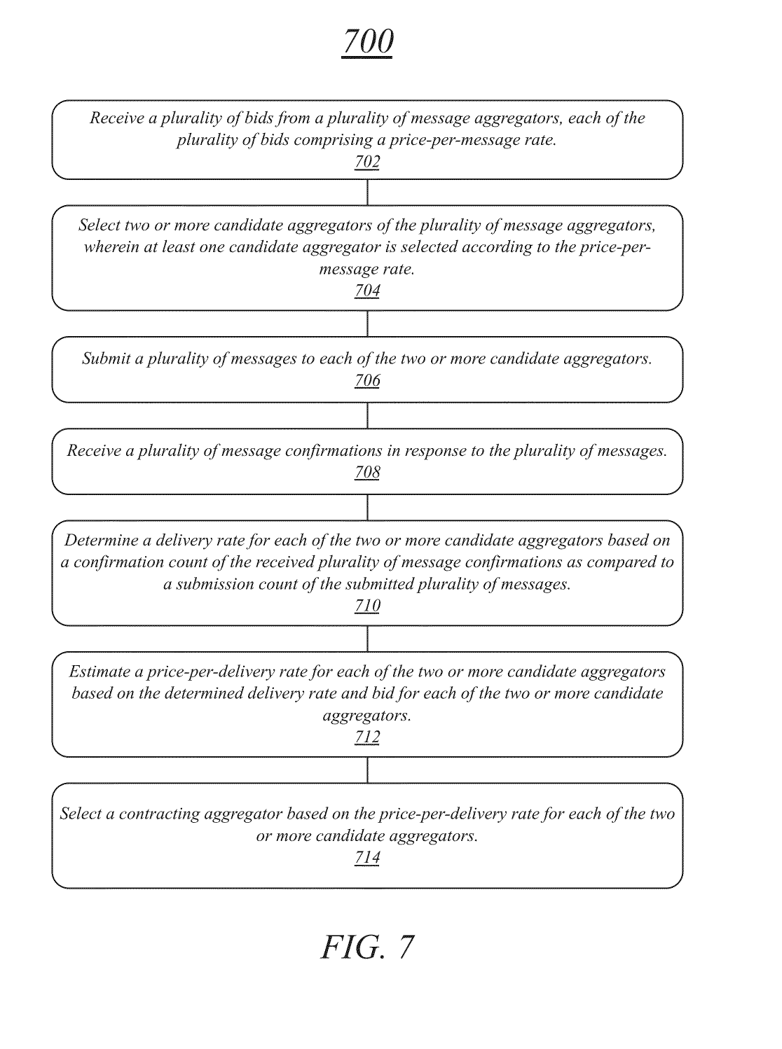

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may receive a plurality of bids 210 from a plurality of message aggregators 160, each of the plurality of bids 210 comprising a price-per-message rate at block 702. The plurality of bids 210 may be received as bids for message aggregation for a network-based service.

The logic flow 700 may select two or more candidate aggregators 260 of the plurality of message aggregators 160, wherein at least one candidate aggregator is selected according to the price-per-message rate at block 704.

The logic flow 700 may submit a plurality of messages 270 to each of the two or more candidate aggregators 260 at block 706. The plurality of messages 270 transmitted from the network-based service to users of a network-based service. The plurality of messages 270 may comprise mobile phone registration confirmation messages, the mobile phone registration confirmation messages produced in response to registration of mobile phones with the network-based service.

The logic flow 700 may receive a plurality of message confirmations 280 in response to the plurality of messages 270 at block 708. The message confirmations 280 may confirm the validity of a mobile phone registration with the network-based service.

The logic flow 700 may determine a delivery rate for each of the two or more candidate aggregators 260 based on a confirmation count of the received plurality of message confirmations 280 as compared to a submission count of the submitted plurality of messages 270 at block 710.

The logic flow 700 may estimate a price-per-delivery rate for each of the two or more candidate aggregators 260 based on the determined delivery rate and bid for each of the two or more candidate aggregators 260 at block 712.

The logic flow 700 may select a contracting aggregator 290 based on the price-per-delivery rate for each of the two or more candidate aggregators 260 at block 714. The contracting aggregator 290 may be automatically transmitted an acceptance of their bid in response to their selection as the contracting aggregator 290. A messaging server 140 may be automatically configured to use the contracting aggregator 290 in response to their selection as the contracting aggregator 290.

The embodiments are not limited to this example.

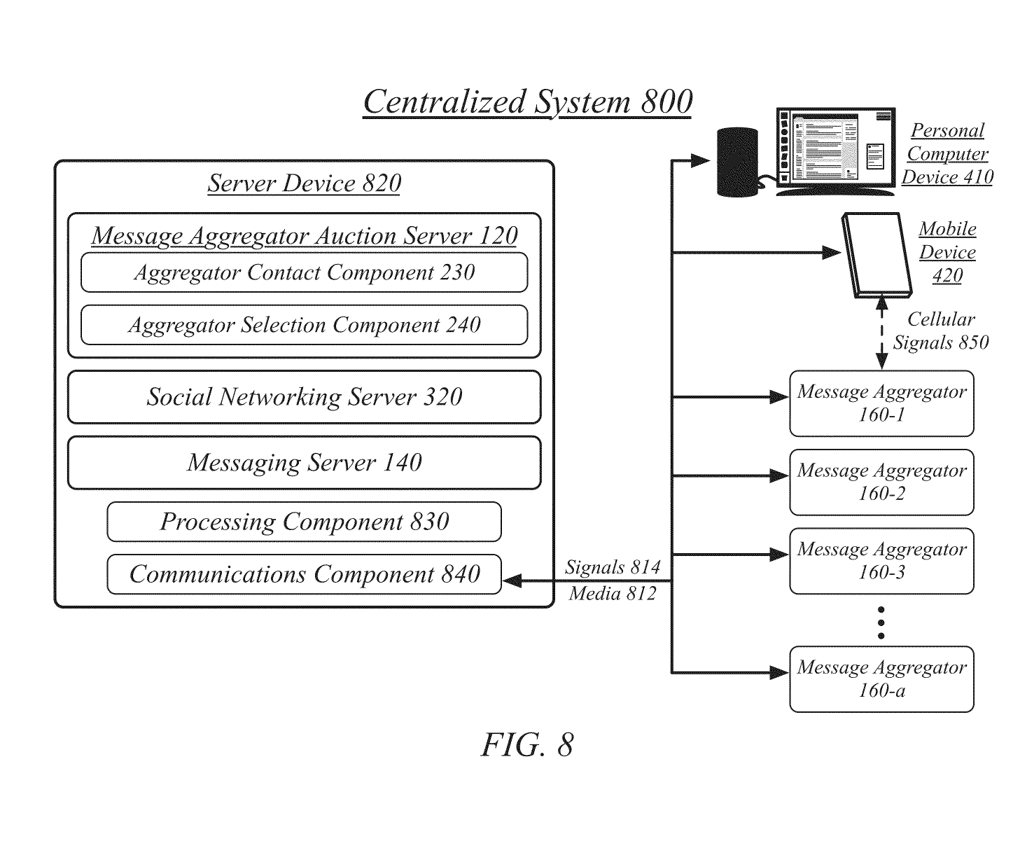

FIG. 8 illustrates a block diagram of a centralized system 800. The centralized system 800 may implement some or all of the structure and/or operations for the message aggregator auction system 100 in a single computing entity, such as entirely within a single device 820.

The device 820 may comprise any electronic device capable of receiving, processing, and sending information for the message aggregator auction system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the message aggregator auction system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the message aggregator auction system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices over a communications media 812 using communications signals 814 respectively, via the communications component 840. The other devices may be internal or external to the device 820 as desired for a given implementation.

A server device 820 may implement the messaging and message aggregator selection functionality of a network-based service in a single computing device. For instance, the server device 820 may implement the message aggregator auction server 120, social networking server 320, and messaging server 140. The server device 820 may communicate with message aggregators 160 (including candidate aggregators 260), personal computer device 410, and/or mobile device 420 using signals 814 sent over media 812. One or more of the message aggregators 160 may also communicate with the mobile device 420, such as by using cellular signals 850. Cellular signals 850 may be produced by a cellular operator for the mobile device 420 in response to the reception of an SMS message from one of the message aggregators 160, the cellular signals 850 carrying the SMS message.

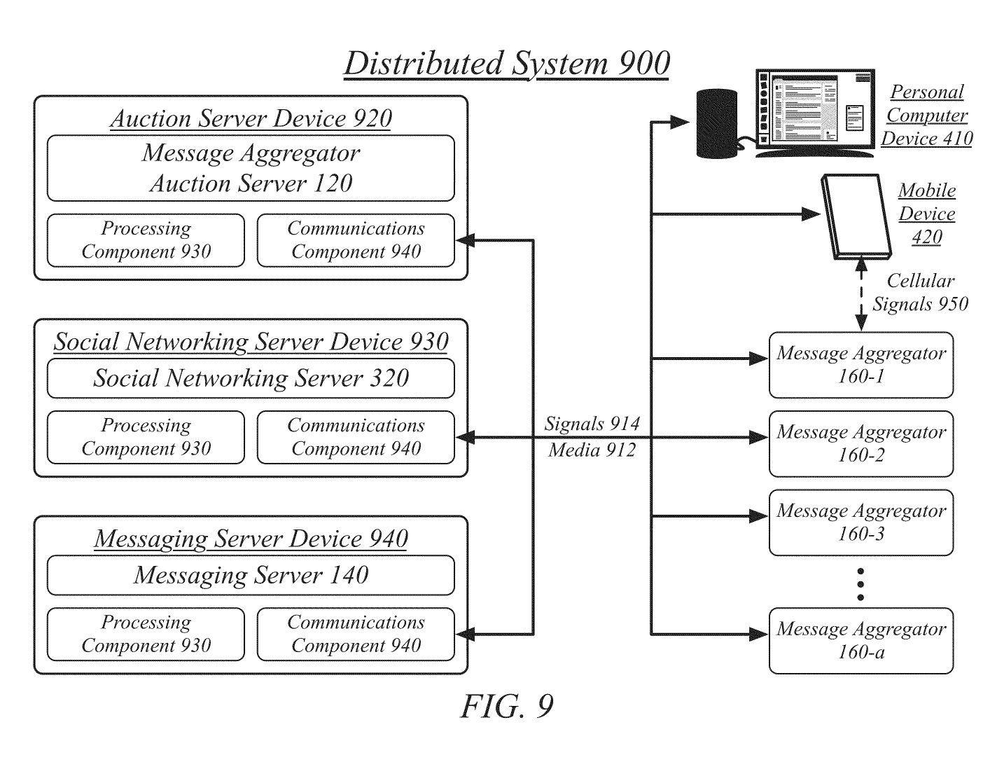

FIG. 9 illustrates a block diagram of a distributed system 900. The distributed system 900 may distribute portions of the structure and/or operations for the message aggregator auction system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise an auction server device 920, social networking server device 930, and messaging server device 940. In general, the auction server device 920, social networking server device 930, and messaging server device 940 may be the same or similar to the client device 820 as described with reference to FIG. 8. For instance, the auction server device 920, social networking server device 930, and messaging server device 940 may each comprise a processing component 930 and a communications component 940 which are the same or similar to the processing component 830 and the communications component 840, respectively, as described with reference to FIG. 8. In another example, the devices 920, 930, 940 may communicate over a communications media 912 using communications signals 914 via the communications components 940.

The auction server device 920 may comprise or employ one or more client programs that operate to perform various methodologies in accordance with the described embodiments. In one embodiment, for example, the auction server device 920 may implement the message aggregator auction server 120. It will be appreciate that in some embodiments a plurality of devices may jointly implement the message aggregator auction server 120.

The social networking server device 930 may comprise or employ one or more client programs that operate to perform various methodologies in accordance with the described embodiments. In one embodiment, for example, the social networking server device 930 may implement the social networking server 320. It will be appreciate that in some embodiments a plurality of devices may jointly implement the social networking server 320.

The messaging server device 940 may comprise or employ one or more client programs that operate to perform various methodologies in accordance with the described embodiments. In one embodiment, for example, the messaging server device 940 may implement the messaging server 140. It will be appreciate that in some embodiments a plurality of devices may jointly implement the messaging server 140.

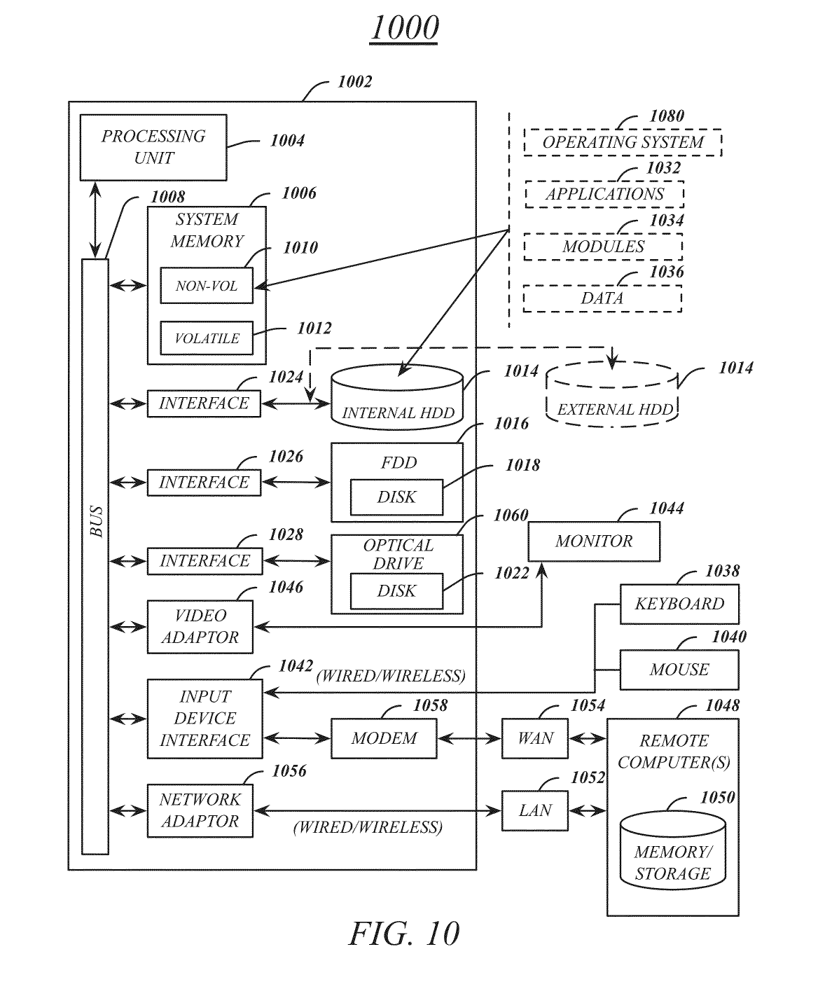

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described with reference to FIGS. 8, 9, and 12, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the message aggregator auction system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.10 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.10x (a, b, g, n, etc.) to provide secure, reliable, fast wireless connectivity. A Wi-Fi network can be used to connect computers to each other, to the Internet, and to wire networks (which use IEEE 802.3-related media and functions).

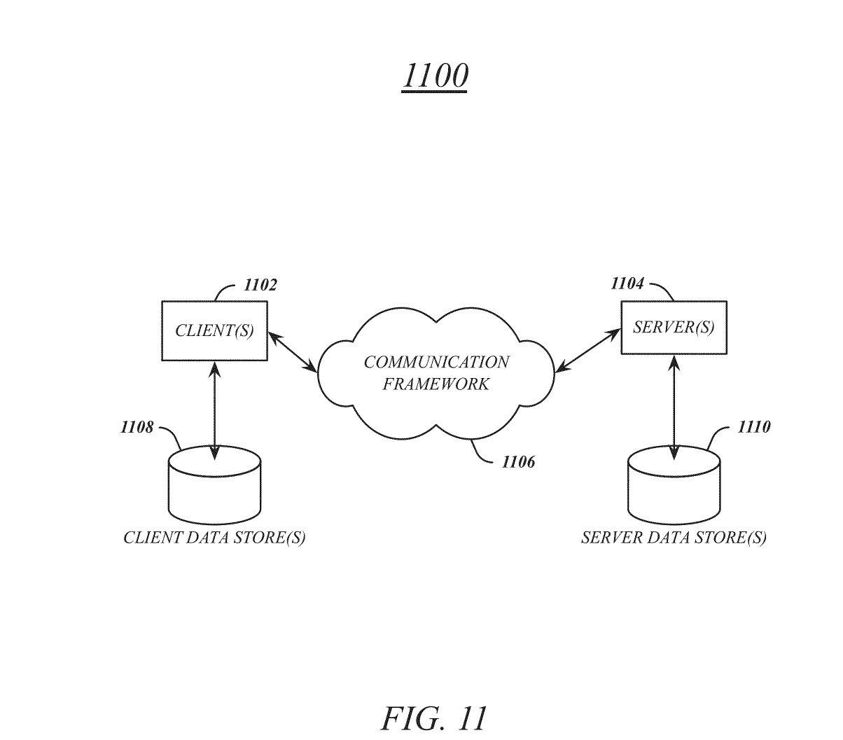

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The servers 1104 may implement the server device 950. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

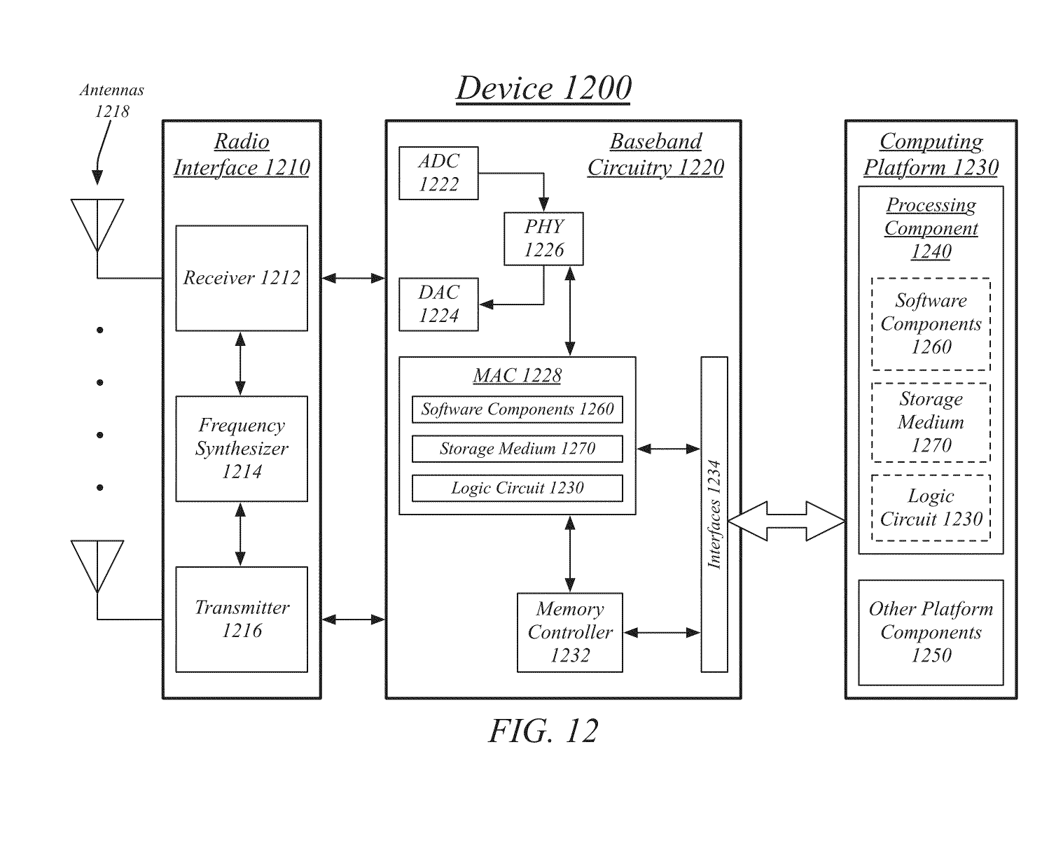

FIG. 12 illustrates an embodiment of a device 1200 for use in a multicarrier OFDM system, such as the message aggregator auction system 100. Device 1200 may implement, for example, software components 1260 as described with reference to message aggregator auction system 100 and/or a logic circuit 1230. The logic circuit 1230 may include physical circuits to perform operations described for the message aggregator auction system 100. As shown in FIG. 12, device 1200 may include a radio interface 1210, baseband circuitry 1220, and computing platform 1230, although embodiments are not limited to this configuration.

The device 1200 may implement some or all of the structure and/or operations for the message aggregator auction system 100 and/or logic circuit 1230 in a single computing entity, such as entirely within a single device. Alternatively, the device 1200 may distribute portions of the structure and/or operations for the message aggregator auction system 100 and/or logic circuit 1230 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1210 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1210 may include, for example, a receiver 1212, a transmitter 1216 and/or a frequency synthesizer 1214. Radio interface 1210 may include bias controls, a crystal oscillator and/or one or more antennas 1218. In another embodiment, radio interface 1210 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1220 may communicate with radio interface 1210 to process receive and/or transmit signals and may include, for example, an analog-to-digital converter 1222 for down converting received signals, a digital-to-analog converter 1224 for up converting signals for transmission. Further, baseband circuitry 1220 may include a baseband or physical layer (PHY) processing circuit 1256 for PHY link layer processing of respective receive/transmit signals. Baseband circuitry 1220 may include, for example, a processing circuit 1228 for medium access control (MAC)/data link layer processing. Baseband circuitry 1220 may include a memory controller 1232 for communicating with processing circuit 1228 and/or a computing platform 1230, for example, via one or more interfaces 1234.

In some embodiments, PHY processing circuit 1226 may include a frame construction and/or detection module, in combination with additional circuitry such as a buffer memory, to construct and/or deconstruct communication frames, such as radio frames. Alternatively or in addition, MAC processing circuit 1228 may share processing for certain of these functions or perform these processes independent of PHY processing circuit 1226. In some embodiments, MAC and PHY processing may be integrated into a single circuit.

The computing platform 1230 may provide computing functionality for the device 1200. As shown, the computing platform 1230 may include a processing component 1240. In addition to, or alternatively of, the baseband circuitry 1220, the device 1200 may execute processing operations or logic for the message aggregator auction system 100 and logic circuit 1230 using the processing component 1240. The processing component 1240 (and/or PHY 1226 and/or MAC 1228) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1230 may further include other platform components 1250. Other platform components 1250 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1200 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1200 described herein, may be included or omitted in various embodiments of device 1200, as suitably desired. In some embodiments, device 1200 may be configured to be compatible with protocols and frequencies associated one or more of the 3GPP LTE Specifications and/or IEEE 1202.16 Standards for WMANs, and/or other broadband wireless networks, cited herein, although the embodiments are not limited in this respect.

Embodiments of device 1200 may be implemented using single input single output (SISO) architectures. However, certain implementations may include multiple antennas (e.g., antennas 1218) for transmission and/or reception using adaptive antenna techniques for beamforming or spatial division multiple access (SDMA) and/or using MIMO communication techniques.

The components and features of device 1200 may be implemented using any combination of discrete circuitry, application specific integrated circuits (ASICs), logic gates and/or single chip architectures. Further, the features of device 1200 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1200 shown in the block diagram of FIG. 12 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving a plurality of bids from a plurality of message aggregators, each of the plurality of bids comprising a price-per-message rate;
selecting two or more candidate aggregators of the plurality of message aggregators, wherein at least one candidate aggregator is selected according to the price-per-message rate;
submitting a plurality of messages to each of the two or more candidate aggregators;
receiving a plurality of message confirmations in response to the plurality of messages;
determining a delivery rate for each of the two or more candidate aggregators based on a confirmation count of the received plurality of message confirmations as compared to a submission count of the submitted plurality of messages;
estimating a price-per-delivery rate for each of the two or more candidate aggregators based on the determined delivery rate and bid for each of the two or more candidate aggregators; and
selecting a contracting aggregator based on the price-per-delivery rate for each of the two or more candidate aggregators.

2. The method of claim 1, the plurality of bids received as bids for message aggregation for a network-based service, the plurality of messages transmitted from the network-based service to users of the network-based service.

3. The method of claim 2, the plurality of messages comprising mobile phone registration confirmation messages, the mobile phone registration confirmation messages produced in response to registration of mobile phones with the network-based service.

4. The method of claim 1, wherein the two or more candidate aggregators are selected based on a minimum threshold pre-auction delivery rate, further comprising:
submitting a plurality of pre-auction messages to the plurality of message aggregators;
receiving a plurality of pre-auction message confirmations in response to the plurality of pre-auction messages; and
determining the pre-auction delivery rate for each of the plurality of message aggregators based on a pre-auction confirmation count of the received plurality of pre-auction message confirmations as compared to a pre-auction submission count of the submitted plurality of pre-auction messages.

5. The method of claim 1, wherein at least one candidate aggregator of the two or more candidate aggregators is selected according to a pre-auction price-per-delivery rate, further comprising:
submitting a plurality of pre-auction messages to the plurality of message aggregators;
receiving a plurality of pre-auction message confirmations in response to the plurality of pre-auction messages;
determining a pre-auction delivery rate for each of the plurality of message aggregators based on a pre-auction confirmation count of the received plurality of pre-auction message confirmations as compared to a pre-auction submission count of the submitted plurality of pre-auction messages; and
estimating the pre-auction price-per-delivery rate for each of the plurality of message aggregators based on the determined pre-auction delivery rate and bid for each of the plurality of message aggregators.

6. The method of claim 1, the plurality of bids received in a reverse auction, further comprising:
receiving an additional bid from a message aggregator; and
extending a deadline for the reverse auction in response to receiving the additional bid.

7. The method of claim 1, further comprising:
transmitting the contracting aggregator an acceptance of a bid for the contracting aggregator, the acceptance automatically transmitted in response to the selecting of the contracting aggregator; and
configuring a messaging server to use the contracting aggregator, the configuring automatically performed in response to the selecting of the contracting aggregator.

8. An apparatus, comprising:
a processor circuit on a device;
an aggregator contact component operative on the processor circuit to receive a plurality of bids from a plurality of message aggregators, each of the plurality of bids comprising a price-per-message rate;
an aggregator selection component operative on the processor circuit to select two or more candidate aggregators of the plurality of message aggregators, wherein at least one candidate aggregator is selected according to the price-per-message rate, receive a plurality of message confirmations in response to a plurality of messages submitted to each of the two or more candidate aggregators, determine a delivery rate for each of the two or more candidate aggregators based on a confirmation count of the received plurality of message confirmations as compared to a submission count of the submitted plurality of messages, estimate a price-per-delivery rate for each of the two or more candidate aggregators based on the delivery rate and bid for each of the two or more candidate aggregators, and select a contracting aggregator based on the price-per-delivery rate for each of the two or more candidate aggregators; and
a messaging component operative on the processor circuit to submit the plurality of messages to each of the two or more candidate aggregators.

9. The apparatus of claim 8, the plurality of bids received as bids for message aggregation for a network-based service, the plurality of messages from the network-based service to users of the network-based service.

10. The apparatus of claim 9, the messages comprising mobile phone registration confirmation messages, the mobile phone registration confirmation messages produced in response to registration of mobile phones with the network-based service.

11. The apparatus of claim 8, further comprising:
the aggregator selection component operative to select the two or more candidate aggregators based on a minimum threshold pre-auction delivery rate; and
the messaging component operative to submit a plurality of pre-auction messages to the plurality of message aggregators, receive a plurality of pre-auction message confirmations in response to the plurality of pre-auction messages, and determine the pre-auction delivery rate for each of the plurality of message aggregators based on a pre-auction confirmation count of the received plurality of pre-auction message confirmations as compared to a pre-auction submission count of the submitted plurality of pre-auction messages.

12. The apparatus of claim 8, further comprising:
the aggregator selection component operative to estimate a pre-auction price-per-delivery rate for each of the plurality of message aggregators based on the determined pre-auction delivery rate and bid for each of the plurality of message aggregators and select at least one candidate aggregator of the two or more candidate aggregators according to the pre-auction price-per-delivery rate; and
the messaging component operative to submit a plurality of pre-auction messages to the plurality of message aggregators, receive a plurality of pre-auction message confirmations in response to the plurality of pre-auction messages, and determine the pre-auction delivery rate for each of the plurality of message aggregators based on a pre-auction confirmation count of the received plurality of pre-auction message confirmations as compared to a pre-auction submission count of the submitted plurality of pre-auction messages.

13. The apparatus of claim 8, the plurality of bids received in a reverse auction, further comprising:
the aggregator contact component operative to receive an additional bid from a message aggregator, generate an extended deadline for the reverse auction in response to receiving the additional bid, and notify the plurality of message aggregators of the extended deadline.

14. The apparatus of claim 8, further comprising:
the aggregator contact component operative to transmit the contracting aggregator an acceptance of a bid for the contracting aggregator, the acceptance automatically transmitted in response to the selecting of the contracting aggregator; and
the aggregator selection component operative to configure a messaging server to use the contracting aggregator, the configuring automatically performed in response to the selecting of the contracting aggregator.

15. At least one computer-readable storage medium comprising instructions that, when executed, cause a system to:
receive a plurality of bids from a plurality of message aggregators, each of the plurality of bids comprising a price-per-message rate;
select two or more candidate aggregators of the plurality of message aggregators, wherein at least one candidate aggregator is selected according to the price-per-message rate;
submit a plurality of messages to each of the two or more candidate aggregators;
receive a plurality of message confirmations in response to the plurality of messages;
determine a delivery rate for each of the two or more candidate aggregators based on a confirmation count of the received plurality of message confirmations as compared to a submission count of the submitted plurality of messages;
estimate a price-per-delivery rate for each of the two or more candidate aggregators based on the determined delivery rate and bid for each of the two or more candidate aggregators; and
select a contracting aggregator based on the price-per-delivery rate for each of the two or more candidate aggregators.

16. The computer-readable storage medium of claim 15, the plurality of bids received as bids for message aggregation for a network-based service, the plurality of messages transmitted from the network-based service to users of the network-based service.

17. The computer-readable storage medium of claim 16, the plurality of messages comprising mobile phone registration confirmation messages, the mobile phone registration confirmation messages produced in response to registration of mobile phones with the network-based service.

18. The computer-readable storage medium of claim 15, wherein the two or more candidate aggregators are selected based on a minimum threshold pre-auction delivery rate, comprising further instructions that, when executed, cause a system to:
submit a plurality of pre-auction messages to the plurality of message aggregators;
receive a plurality of pre-auction message confirmations in response to the plurality of pre-auction messages; and
determine the pre-auction delivery rate for each of the plurality of message aggregators based on a pre-auction confirmation count of the received plurality of pre-auction message confirmations as compared to a pre-auction submission count of the submitted plurality of pre-auction messages.

19. The computer-readable storage medium of claim 15, wherein at least one candidate aggregator of the two or more candidate aggregators is selected according to a pre-auction price-per-delivery rate, comprising further instructions that, when executed, cause a system to:
submit a plurality of pre-auction messages to the plurality of message aggregators;
receive a plurality of pre-auction message confirmations in response to the plurality of pre-auction messages;
determine a pre-auction delivery rate for each of the plurality of message aggregators based on a pre-auction confirmation count of the received plurality of pre-auction message confirmations as compared to a pre-auction submission count of the submitted plurality of pre-auction messages; and
estimate the pre-auction price-per-delivery rate for each of the plurality of message aggregators based on the determined pre-auction delivery rate and bid for each of the plurality of message aggregators.

20. The computer-readable storage medium of claim 15, comprising further instructions that, when executed, cause a system to:
transmit the contracting aggregator an acceptance of a bid for the contracting aggregator, the acceptance automatically transmitted in response to the selecting of the contracting aggregator; and
configure a messaging server to use the contracting aggregator, the configuring automatically performed in response to the selecting of the contracting aggregator.
